(19) United States
(12) Patent Application Publication
(10) Pub. No.: US 2016/0105077 A1
(43) Pub. Date: Apr. 14, 2016

(54) Lawn Mower Emergency Generator

(71) Applicant: Raleigh Stewart, Centreville, VA (US)

(72) Inventor: Raleigh Stewart, Centreville, VA (US)

(21) Appl. No.: 14/875,761

(22) Filed: Oct. 6, 2015

Related U.S. Application Data
(60) Provisional application No. 62/061,228, filed on Oct. 8, 2014.

(51) Int. Cl. H02K 7/18; A01D 42/00

(52) U.S. Cl. CPC H02K 7/1815; A01D 42/00

(57) ABSTRACT

An apparatus is described that connects a lawn mower to an emergency electrical generator that fits underneath a lawn mower and uses the lawn mower blades to turn the turbine of the emergency electrical generator to produce electricity. This apparatus has a low form factor to fit underneath most commonly available lawn mowers and has an extension that permits the apparatus to be compressed into a smaller form factor for easier storage. The apparatus may also have an adaptor to permit the lawn mower and emergency electrical generator to be easily aligned and to maintain this alignment during operation. The emergency electrical generator has two or more electrical outlets for connection to standard appliance plugs for delivery of electrical current as it is generated.

### PRIORITY

This application claims priority to provisional patent application 62/061,228, filed Oct. 8, 2014, entitled “Lawn Mower Emergency Generator”, which is included herein in its entirety by reference.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

Emergency situations resulting in the loss of electrical power occur infrequently for most individuals who reside in an urban environment. This infrequent occurrence means that most urban dwellers are unprepared for the loss of electrical power and the sudden need for an emergency generator. A full electrical generator backup system can alleviate this problem, but is often costly to install and difficult to operate. A backup electrical generator that does not require a permanent installation, and takes advantage of equipment that urban dwellers already own and are skilled at operating, is a more valuable solution.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 presents an exemplary front view of a lawn mower attached to the generator assembly consistent with certain embodiments of the present invention.

FIG. 2 presents an exemplary side view of a lawn mower attached to the generator assembly consistent with certain embodiments of the present invention.

FIG. 3 presents an exemplary view of the upper surface of the emergency generator assembly extended for use consistent with certain embodiments of the present invention.

FIG. 4 presents an exemplary view of the bottom of the emergency generator assembly consistent with certain embodiments of the present invention.

FIG. 5 presents an exemplary view of a vertical peg blade power transfer mechanism of the emergency generator assembly consistent with certain embodiments of the present invention.

FIG. 6 presents an exemplary view of a magnetic blade alignment assembly consistent with certain embodiments of the present invention.

FIG. 7 presents an exemplary view of a lawn mower blade mounting adaptor of the emergency generator assembly consistent with certain embodiments of the present invention.

FIG. 8 presents an exemplary view of a lawn mower blade attachment to the emergency generator assembly consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. The terms “a” or “an”, as used herein, are defined as one or more than one.

The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

The term “post” as used herein is to be interpreted as meaning a tab or peg connected at one end to a surface and the other end free from any connection to any structure herein expressed.

A gasoline powered emergency generator is very infrequently used by most individuals, but can be an asset in times of emergencies. The occurrence of an emergency situation severe enough to cause the loss of electrical power poses various challenges to most individuals.

A dedicated gasoline powered emergency generator is typically very heavy and bulky, and takes up space during storage that can often be used for other purposes. A gasoline powered emergency generator is often difficult or impossible to store on a shelf or in a loft, unless the shelf or loft is specifically designed to bear such a load. Once filled with fuel, such emergency generators contain combustible liquids, posing further limits on the options for storage locations.

Because emergency generators are operated infrequently, the emergency generators are susceptible to various maintenance issues such as, although this is not to be considered an exhaustive list, accumulating sludge and dirt in the engine components. Without regular operation and maintenance, the generator may fail to operate when it is most needed. The infrequent use and often high cost of a gasoline powered emergency generator may deter many individuals who are considering purchasing and utilizing such an emergency generator from actually purchasing the apparatus.

In an exemplary embodiment, an emergency generator may be constructed to utilize a power source that is commonly owned and operated by most individuals who grow and maintain a grass lawn such as a lawn mower. The lawn mower emergency generator could be used by individuals to provide a source of electricity during a power outage or other emergency requiring electrical power to be accessible in a location without access to the electrical power grid. In an exemplary embodiment, the gasoline powered emergency generator may have an extension component that refracts under the body of the emergency generator when not in use, and may be extended when in use. The extension component may permit the emergency generator to be compacted into a smaller form factor when the extension component is refracted into the emergency generator base. When in use, the extension component is extended from the base of the emergency generator to form a configuration of sufficient size to accommodate the attachment to one or more commonly used retail-style lawn mowers. When not in use, the lawn mower emergency generator could be stored in a smaller space than a comparable dedicated gasoline powered emergency generator by retracting the extension component into the body of the emergency generator.

In an embodiment, the lawn mower emergency generator makes use of a readily available, frequently used, and familiar gasoline-fueled power source. Because the power source is separate from the emergency generator itself, the emergency generator may be lighter in weight and smaller in size, permitting the lawn mower emergency generator to take up less space in storage, to be stored indoors if desired, and reduces the likelihood that the gasoline engine would not operate when the need arose. Additionally, the cost of the lawn mower emergency generator would be lower than that of a comparable gasoline powered emergency generator due to the fact that the gasoline engine is not included in the cost of the lawn mower emergency generator.

In an exemplary embodiment, the lawn mower emergency generator interfaces with the blade drive of a regular residential lawn mower without any modifications to the mower. The user would preferably tilt the mower back on the rear wheels, position the mower blade over the interface coupling, and lowers the mower blade to initiate contact with the interface coupling. The coupling and mower position are adjusted to ensure that the mower output shaft is aligned with the center of the coupling, without the use of any tools. The power transfer between the mower blade and generator rotor is facilitated by a tool-less centering adapter and guide system to help perform initial axial alignment and to continue to maintain axial alignment during operation of the system.

The interface coupling is in the form of a tapered alignment adaptor cap that is fitted to the mower blade mounting bolt head, and a tapered alignment hole in the generator rotor. The alignment cap may be installed on the bolt and is held in place by a slight interference fit, or through the use of a magnet installed within the alignment cap. With the alignment cap in place, the user may then easily guide the mower into position so that the mower blade and generator rotor are axially aligned. The interface coupling mechanism will translate the motion of the mower blade into drive force for the emergency generator rotor and generate power at the output electrical sockets of the lawn mower emergency generator set.

In an embodiment, the lawn mower generator apparatus may have a generator mechanism with a flat upper surface of sufficient height to fit under a typical hand propelled lawn mower with a generator interface rotor connected to the generator drive central shaft at the centroid of the generator interface rotor. The apparatus may have at least one peg connected at the proximate end of the generator interface rotor and at least one peg connected at the distal end of the generator interface rotor, with each peg extending vertically from the upper surface of the generator interface rotor, with the pegs configured to permit the insertion of a lawn mower blade between the pegs and the lawn mower blade in contact with the pegs. In this exemplary embodiment, the generator interface rotor is configured to spin around the centroid when force is applied to the pegs from the lawn mower blade and transfer mechanical force from the lawn mower blade to a drive mechanism. The drive mechanism is connected to an electrical generator so as to operate the electrical generator and generate electricity, where the generated electricity is available to a user from one or more electrical outlets extending from the generator mechanism. The generator mechanism may have an extension that contracts into the body of the apparatus to create a smaller form factor for easier storage of the apparatus.

In an exemplary embodiment, the drive pegs may be connected at the proximate end of the generator interface rotor and at the distal end of the generator interface rotor, each peg extending a sufficient distance vertically to be in contact with a lawn mower blade when the apparatus is positioned beneath a lawn mower. The drive mechanism may transfer the mechanical force from the drive mechanism to the electrical generator through a belt connected from a circular drive wheel at the base of the drive mechanism to a circular drive wheel at the base of the electrical generator. The circular drive wheel at the base of the electrical generator may be connected to the rotor in such a manner as to turn the rotor in direct proportion to the motion of the circular drive wheel, where the turning of the rotor causes the generation of electricity. The emergency generator may have one or more indicator lights associated with the electrical generator to present operational information.

In an exemplary embodiment, the drive connection may have a tapered centering adaptor for positioning the mower blade in the proper operational position with relation to the generator interface rotor, with a tapered centering depression in the generator interface rotor to receive the tapered centering adaptor. Additionally, a magnet disposed at the center of the tapered centering adaptor and operative to attract and maintain contact with a blade mounting bolt on a lawn mower. In an alternative configuration, the tapered centering adaptor may be mechanically connected to a blade mounting bolt through a slight interference fit between the blade mounting bolt and the tapered centering adaptor.

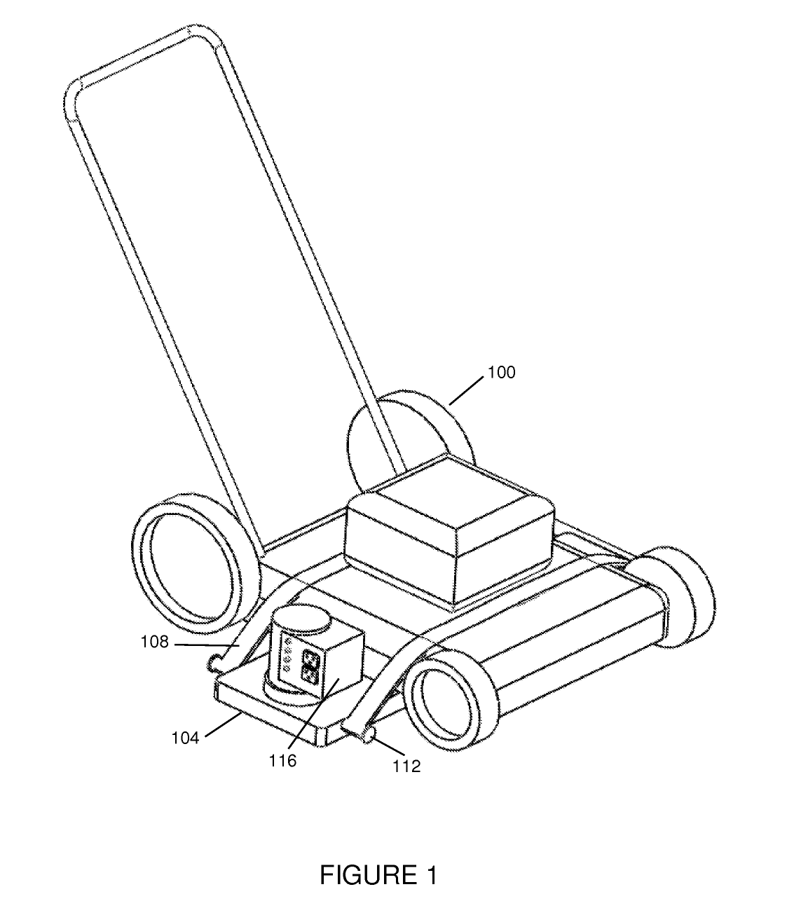

Turning now to FIG. 1, this figure presents a side view of the generator assembly with the interface coupling at the center of the apparatus consistent with certain embodiments of the present invention. A lawn mower 100 is attached to the top portion of an emergency generator assembly 104 through the use of one or more fastening straps 108. In this non-limiting example, two straps 108 are fastened to the emergency generator assembly 104 at dedicated connection points 112 on the proximate portion of the emergency generator assembly 104, passing over the top portion of the lawn mower 100 and attached at additional connection points 112 (not shown) on the distal portion of the emergency generator assembly 104. This exemplary connection is only one of many strap configurations and should not be considered limiting.

In this exemplary embodiment, the emergency generator assembly 104 passes under the entirety of the body of the lawn mower 100. The emergency generator assembly 104 extends to either side of the lawn mower 100 a sufficient distance to permit the installation of the connection straps 108 and permit access to power outlets 116 from which the electricity generated by the emergency generator assembly 104 is supplied.

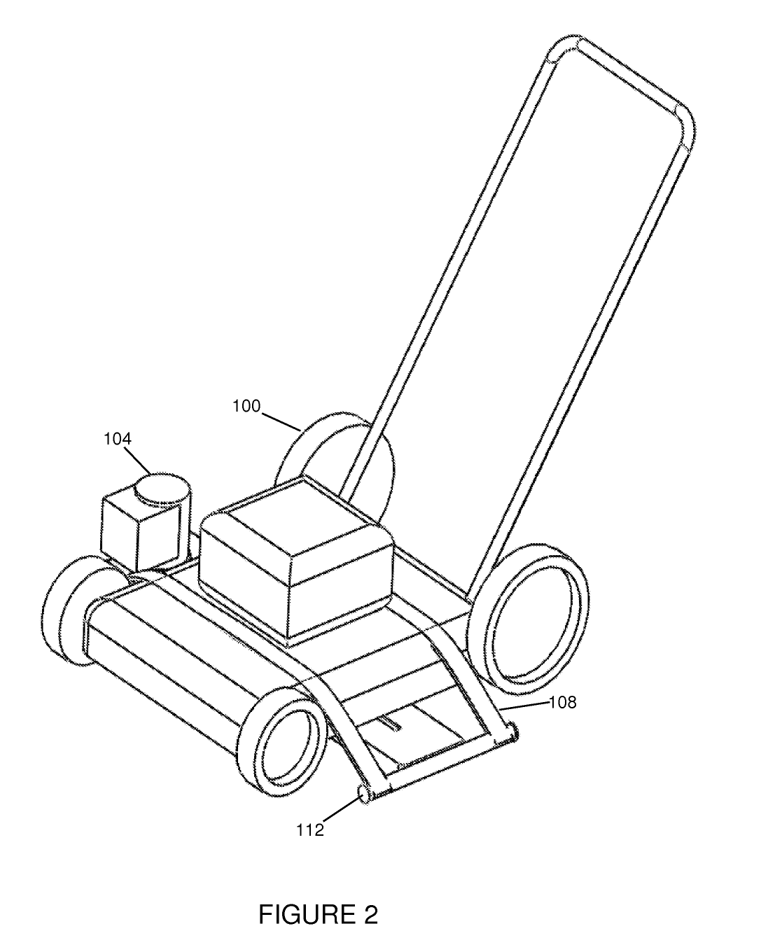

Turning now to FIG. 2, this figure presents an exemplary side view of a lawn mower 100 attached to the emergency generator assembly 104 consistent with certain embodiments of the present invention. In this exemplary embodiment, the emergency generator assembly 104 distal portion is shown extending from beneath the lawn mower 100. The distal portion is attached to a strap connection point 112. In this non-limiting example, two straps 108 are connected over the upper surface of the lawn mower 100 to a strap connection point (not shown) attached to the proximate portion of the emergency generator assembly 104. In this configuration, the lawn mower is strapped to the emergency generator assembly 104 in a secure manner, so as to preclude the separation of the lawn mower 100 and the emergency generator assembly 104 when the lawn mower 100 is in operation. The operation of the lawn mower 100 is the motive force required to permit the generation of electricity from the emergency generator assembly 104.

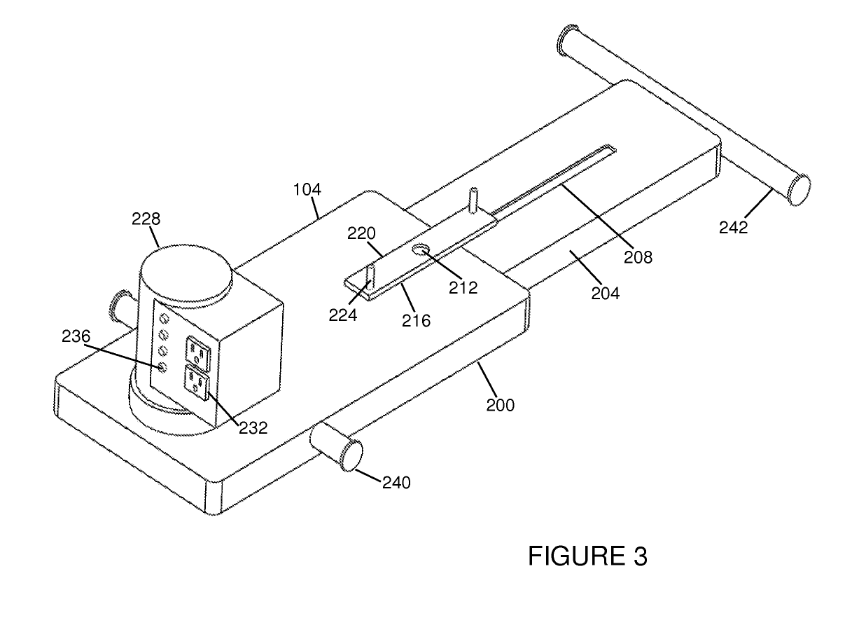

Turning now to FIG. 3, this figure presents an exemplary view of the upper surface of the emergency generator assembly 104 extended for use consistent with certain embodiments of the present invention. In an exemplary embodiment, the emergency generator assembly 104 is composed of a base portion 200 and an extendible insert portion 204 that extends from the base portion 200 to permit the accommodation and connection with lawn mowers of various body widths.

The base portion 200 of the emergency generator assembly 104 is manufactured from metal, metallic, or high-impact plastic materials that are capable of withstanding the weight and angular force of a lawn mower during operation of the emergency generator assembly 104. The extensible insert portion 204 is manufactured of the same materials as the base portion 200 and has a central cutout channel 208 to permit the extensible insert portion 204 to be inserted and pulled out from the base portion 200 without impacting or interfering with a central drive axis 212.

The blade drive mechanism 216 may be connected to the top surface of the emergency generator assembly 104 by attachment at the center point of the blade drive mechanism 216 to the central drive axis 212. The blade drive mechanism 216 may be composed of a generator interface rotor 220 that is of sufficient length to fit underneath a lawn mower having a typical cutting swath and blade length. In a non-limiting example, the generator interface rotor 220 would be of sufficient length to be used with a lawn mower having a cutting blade 24 inches in length. In this exemplary embodiment, the blade drive mechanism 216 may have at least two blade drive pegs 224 extending vertically from the proximate and distal ends of the generator interface rotor 220. The blade drive pegs 224 are configured to be of sufficient height to engage the lawn mower blade (not shown) when the lawn mower is connected to the emergency generator assembly 104 and placed in operation. With the lawn mower in operation, the lawn mower blade will be in contact with the blade drive pegs 224 of the blade drive mechanism 216 and provide the axial drive force to turn the drive mechanism generator interface rotor 220 around the central drive axis 212 to provide the force needed to operate the emergency generator 228 and generate electricity.

In this exemplary embodiment, the emergency generator assembly 104 may have an electric generator 228 mounted to the top surface of the emergency generator assembly 104, with the central drive axis of the electric generator (not shown) extending through the top surface of the emergency generator assembly 104 to the underside of the emergency generator assembly 104. Connected to the electric generator 228 may be one or more electrical outlets 232 and operation indicator lights 236. The electrical outlets 232 are configured as standard plugs capable of accepting a single phase plug with a ground peg from a cord extending from a device requiring electrical current or an extension cord used to deliver electricity to one or more devices located some distance away from the emergency generator assembly 104.

Strap connection points are attached at both the proximate 240 and distal 242 ends of the emergency generator assembly 104. Straps of sufficient strength may be connected from the proximate strap connection point 240 to the distal strap connection point 242 of the emergency generator assembly 104 to provide a strong, stable connection between the emergency generator assembly 104 to the lawn mower (not shown) when the system is in operation.

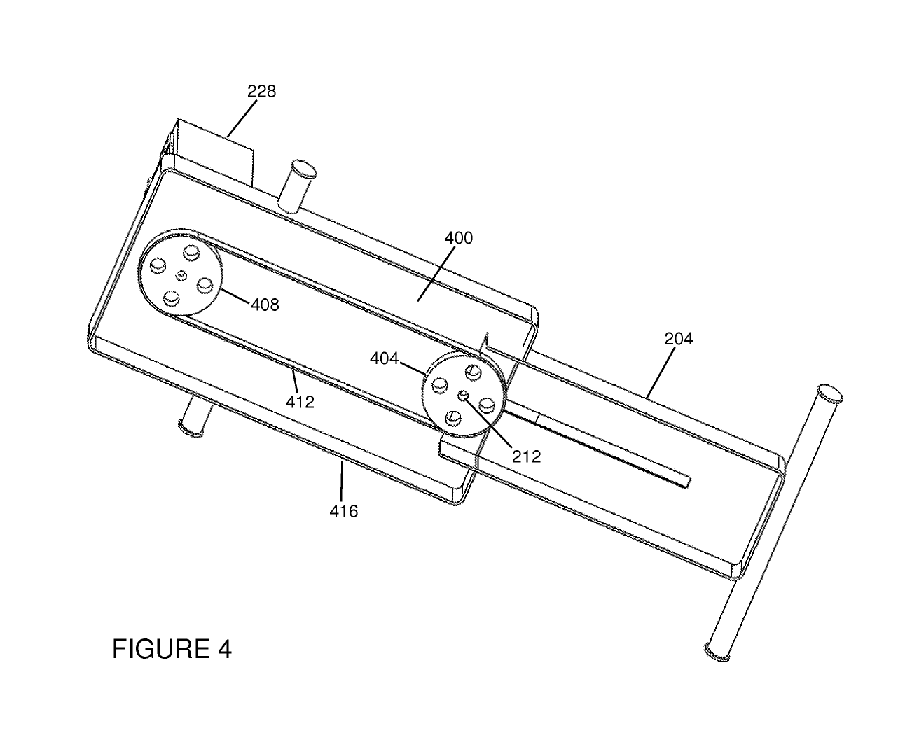

Turning now to FIG. 4 this figure presents an exemplary view of the bottom of the emergency generator assembly 104 consistent with certain embodiments of the present invention. In this exemplary embodiment, the bottom side 400 of the emergency generator assembly 104 is configured to permit the translation of the mechanical energy of the lawn mower (not shown) to the emergency generator 228.

In an exemplary embodiment, the central drive axis 212 of the blade drive mechanism (see FIG. 3) extends through the top portion of the emergency generator assembly 104 to the underside 400 of the emergency generator assembly 104 and connects to a blade drive wheel 404. The blade drive wheel 404 is of sufficient diameter to fit wholly within the channel formed by the emergency generator extensible insert portion 204 when that portion is fully retracted into the body 416 of the emergency generator assembly 104. A generator drive wheel 408 is connected from the underside of the emergency generator assembly 400 through the body of the emergency generator assembly 104 to the drive mechanism of the emergency generator (not shown). The generator drive wheel 408 is of similar diameter to the blade drive wheel 404 so as to provide a smooth transfer of mechanical energy from the blade drive wheel 404 to the generator drive wheel 408 and then to the electrical generator drive mechanism (not shown).

The blade drive wheel 404 is mechanically connected to the central drive axis 212 of the blade drive mechanism (not shown). The blade drive wheel 404 is connected to the generator drive wheel 408 through the use of a drive belt 412. The drive belt 412 may be manufactured of a synthetic material, vulcanized rubber, metal chain, or any other material that has sufficient strength to hold tension between the blade drive wheel 404 and the generator drive wheel 408 so as to transfer the axial force from the blade drive (not shown) to the electric generator (not shown).

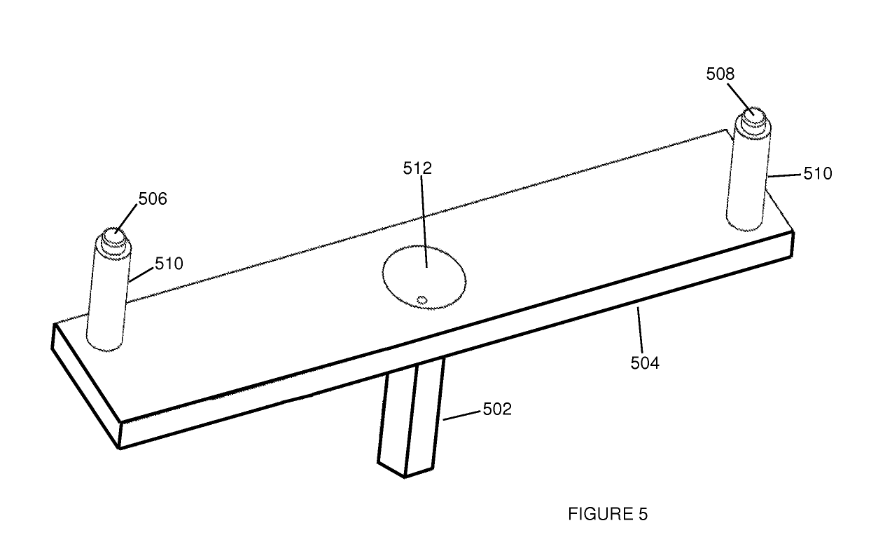

Turning now to FIG. 5 this figure presents an exemplary view of a vertical peg blade power transfer mechanism of the emergency generator assembly consistent with certain embodiments of the present invention. In this exemplary embodiment the generator drive central shaft 502 is a shaft that is connected from the emergency generator drive mechanism (not shown) to the centroid of the generator interface rotor 504. The generator drive central shaft 502 may be shaped, in a non-limiting example, as a hexagonal shaft that extends from the lower surface of the generator interface rotor 504 and connects to the emergency generator. The generator drive central shaft 502 may also have other geometrical shapes, such as square, rectangular, octagonal, or may be shaped as a cog or other toothed shape without departing from the spirit of the invention. A vertical drive peg 506 is positioned at the proximal end of the generator interface rotor 504, and located at the leading edge of the generator interface rotor 504 when the generator interface rotor 504 is moving in a clockwise direction. A second vertical drive peg 508 is positioned at the distal end of the blade drive generator interface rotor, and located at the leading edge of the generator interface rotor 504 when the generator interface rotor 504 is moving in a clockwise direction. Each vertical drive peg (506, 508) may have a replaceable sleeve bushing 510 installed in contact with each vertical drive peg (506, 508) such that the replaceable sleeve bushing 510 completely covers and isolates each vertical drive peg (506, 508) from contact with a lawn mower blade. The replaceable sleeve bushing 510 may be made of copper, steel, rubber, hardened plastic, or any other material that is resistant to tearing or cutting from contact with the lawn mower blade.

The force of a mower blade pushing against the vertical drive pegs (506, 508) provides the motive force necessary to drive an electric generator. Maximum efficiency in the transfer of power from the mower blade to the generator interface rotor 504 of the blade drive mechanism may be attained when the mower blade is positioned so as to minimize any distance between the mower blade and the vertical drive pegs (506, 508) prior to operation of the emergency generator. To minimize the distance between the mower blade and the blade drive mechanism prior to beginning operation, a tapered centering cavity 512 is provided at the geographic center of the generator interface rotor 504. The center of the mower blade may be placed in contact with the generator interface rotor 504 such that a matching centering element installed on the mower blade will be placed into full contact with the tapered centering cavity 512. With the mower blade in full contact with the tapered centering cavity 512, the user may be assured that the mower blade is positioned properly for optimum power transfer from the mower blade to the blade drive central axis shaft 502.

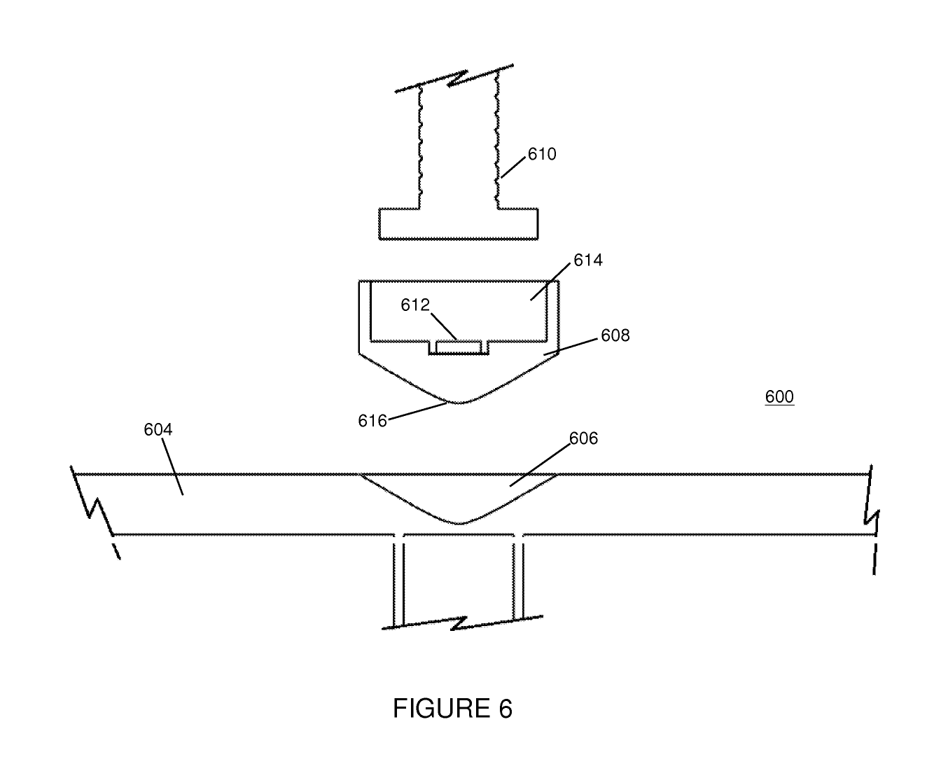

Turning now to FIG. 6, this figure presents an exemplary view of a magnetic blade alignment assembly consistent with certain embodiments of the present invention. In this exemplary embodiment, the blade drive power transfer mechanism 600 may have a generator interface rotor 604 for operational power generation when attached to a lawn mower (not shown). The generator interface rotor 604 may have a tapered centering depression 606 at the centroid of the generator interface rotor 604 and permitting contact with a tapered centering adaptor 608 that is in mechanical connection with the lawn mower blade mounting bolt 610.

In an exemplary embodiment, the lawn mower blade is placed in proper alignment with the generator interface rotor 604 through a tool-less centering adaptor and guide system to perform initial axial alignment between the lawn mower blade and the generator interface rotor 604, and to help maintain this alignment during operational use of the lawn mower/emergency generator combination. The system consists of a tapered centering adaptor 608 within which may be installed a magnet 612. The magnet 612 is positioned at the center bottom of a blade mounting bolt recess 614 into which a blade mounting bolt 610 is inserted to form a mechanical connection between the lawn mower blade and the tapered centering adaptor 608. In an alternative embodiment, the magnet 612 may be omitted and the tapered centering adaptor 608 may be held in place through the mechanism of a slight interference fit between the blade mounting bolt 610 and the blade mounting bolt recess 614. The tapered centering adaptor 608 may be installed on the blade mounting bolt 610 prior to attaching the lawn mower to the emergency generator. The tapered centering adaptor 608 has a tapered exterior surface 616 that is the same shape and approximate size as the tapered centering hole 606 positioned at the centroid of the generator interface rotor 604. When a user intends to use the lawn mower as the motive force for the emergency generator, the user may install the tapered centering adaptor 608 on to the blade mounting bolt 610 and then position the lawn mower over the emergency generator such that the tapered centering adaptor 608 is inserted into the tapered centering hole 606, forming an axial alignment between the lawn mower blade and the generator interface rotor 604. With the lawn mower and the emergency generator in axial alignment, the lawn mower may be started to provide the force to the emergency generator to permit the generation of electricity.

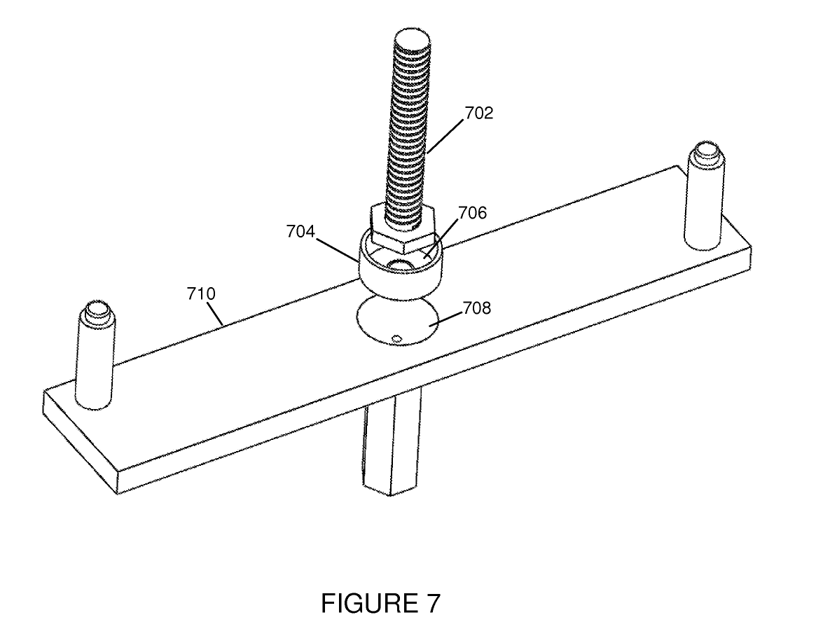

Turning now to FIG. 7, this figure presents an exemplary view of a lawn mower blade mounting adaptor of the emergency generator assembly consistent with certain embodiments of the present invention. In this exemplary embodiment, the lawn mower blade mounting bolt 702 is shown prior to the mechanical connection with the tapered centering adaptor 704. In this exemplary embodiment, the tapered centering adaptor 704 may have a tapered centering adaptor well 706 into which the lawn mower blade mounting bolt 702 is inserted so as to form a mechanical connection and be held in place either through a slight interference fit or through the use of a magnet positioned at the bottom center of the tapered centering adaptor well 706. The tapered centering adaptor 704 may then be inserted into the tapered centering hole 708 located at the centroid of the generator interface rotor 710 to form a mechanical connection in which the lawn mower blade (not shown) and the generator interface rotor 710 are maintained in axial alignment.

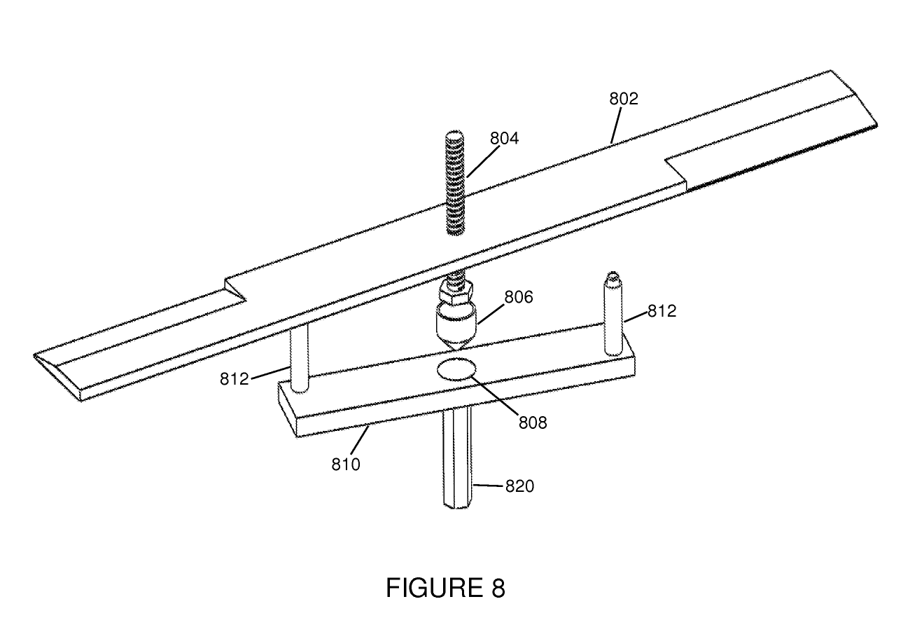

Turning now to FIG. 8, this figure presents an exemplary view of a lawn mower blade attachment to the emergency generator assembly consistent with certain embodiments of the present invention. In this exemplary embodiment, the complete configuration of the lawn mower/emergency generator drive system is presented. When fully assembled, the lawn mower blade 802 is installed in the lawn mower with a blade mounting bolt 804. The blade mounting bolt 804 may have a tapered centering adaptor 806 mechanically or magnetically attached to the blade mounting bolt 804. The lawn mower blade is then axially aligned with the generator interface rotor 810 when the tapered centering adaptor 806 is placed in physical contact with the tapered centering hole 808.

In this exemplary embodiment, the lawn mower blade 802 is now positioned such that the mechanical connection forms an axial alignment between the lawn mower blade 802 and the generator interface rotor 810 so as to align the lawn mower blade 802 in such as manner as to place the edges of the lawn mower blade into contact with the vertical drive pegs 812 located at the distal and proximal ends of the generator interface rotor 810 and extending vertically from the upper surface of the generator interface rotor 810. When the lawn mower is in operation, the mechanical connection between the tapered centering adaptor 806 and the tapered centering hole 808 may help to maintain the axial alignment during operation of the combined lawn mower and emergency generator system.

During operation of the lawn mower the blade may push against the vertical drive pegs 812, transferring mechanical energy from the lawn mower to the generator interface rotor 810 and then to the drive mechanism 820.

While certain illustrative embodiments have been described, it is evident that many alternatives, modifications, permutations and variations will become apparent to those skilled in the art in light of the foregoing description.

What is claimed is:

1. An apparatus comprising:
a generator mechanism with a flat upper surface of sufficient height to fit under a typical hand propelled lawn mower;
a generator interface rotor connected to the generator drive central shaft at the centroid of the generator interface rotor;
at least one peg connected at the proximate end of the generator interface rotor and at least one peg connected at the distal end of the generator interface rotor, with each peg extending vertically from the upper surface of the generator interface rotor;
the pegs configured to permit the insertion of a lawn mower blade between the pegs, with the lawn mower blade in contact with the pegs;
the generator interface rotor configured to spin around the centroid when force is applied to the pegs from the lawn mower blade and transfer mechanical force from the lawn mower blade to a drive mechanism;
the drive mechanism connected to an electrical generator so as to operate the electrical generator and generate electricity;
where the generated electricity is available to a user from one or more electrical outlets extending from the generator mechanism.

2. The apparatus of claim 1 where the at least one peg connected at the proximate end of the generator interface rotor and the at least one peg connected at the distal end of the generator interface rotor each extend a sufficient distance vertically to be in contact with a lawn mower blade when the apparatus is positioned beneath a lawn mower.

3. The apparatus of claim 1 further comprising an extension that contracts into the body of the apparatus to create a smaller form factor for easier storage of the apparatus.

4. The apparatus of claim 1 where the drive mechanism transfers the mechanical force from the drive mechanism to the electrical generator through a belt connected from a circular drive wheel at the base of the drive mechanism to a circular drive wheel at the base of the electrical generator.

5. The apparatus of claim 4, where the circular drive wheel at the base of the electrical generator is connected to the rotor in such a manner as to turn the rotor in direct proportion to the motion of the circular drive wheel, where the turning of the rotor causes the generation of electricity.

6. The apparatus of claim 1 further comprising one or more indicator lights associated with the electrical generator to present operational information.

7. The apparatus of claim 1, further comprising a tapered centering adaptor for positioning the mower blade in the proper operational position with relation to the generator interface rotor.

8. The apparatus of claim 7, further comprising a tapered centering depression in the generator interface rotor to receive the tapered centering adaptor.

9. The apparatus of claim 7, further comprising a magnet disposed at the center of the tapered centering adaptor and operative to attract and maintain contact with a blade mounting bolt on a lawn mower.

10. The apparatus of claim 7, where the tapered centering adaptor is mechanically connected to a blade mounting bolt through a slight interference fit between the blade mounting bolt and the tapered centering adaptor.
